(19) United States
(12) Patent Application Publication
(10) Pub. No.: US 2024/0284834 A1
(43) Pub. Date: Aug. 29, 2024

(54) AGRICULTURAL BALE PRESS

(71) Applicant: Maschinenfabrik Bernard Krone GmbH & Co. KG, Spelle (DE)

(72) Inventor: Thomas KUHLS, Ochtrup (DE)

(21) Appl. No.: 18/586,041

(22) Filed: Feb. 23, 2024

(30) Foreign Application Priority Data
Feb. 27, 2023 (DE) DE102023104765.5

(51) Int. Cl. A01F 15/08

(52) U.S. Cl. CPC A01F 15/08

(57) ABSTRACT

An agricultural bale press, having a press frame, a container device, and a transfer device for transferring the container device from an operating position into a filling position. The bale press has at least a first guide element, which is arranged at one end pivotably about a first frame guide pivot axis on the press frame and at the other end pivotably about a first container guide pivot axis on the container device, and a guide arrangement which is arranged pivotably about a second container guide pivot axis on the container device and includes at least a second guide element which is arranged pivotably about a second frame guide pivot axis on the press frame. The guide arrangement includes at least an intermediate guide element and at least a third guide element.

### CROSS REFERENCE TO RELATED APPLICATIONS

This application claims priority under 35 U.S.C. § 119 to German Patent Application DE 10 2023 104765.5, filed Feb. 27, 2023, which is herein incorporated by reference in its entirety, including without limitation, the specification, claims, and abstract, as well as any figures, tables, appendices, or drawings thereof.

### TECHNICAL FIELD

The present disclosure relates generally to an agricultural bale press. The bale press has a press frame, a container device, and a transfer device. The transfer device is configured for transferring the container device relative to the press frame.

### BACKGROUND

The background description provided herein gives context for the present disclosure. The work of the presently named inventors, as well as aspects of the description that may not otherwise qualify as prior art at the time of filing, are neither expressly nor impliedly admitted as prior art.

Such a bale press is known from EP 2 407 024 B1. The transfer device of the known bale press comprises a total of four guide elements, which each extend from the press frame to the container device and are arranged pivotably about separate pivot axes on the press frame, and a hydraulic cylinder. Thus, the transfer device takes up a large installation space, which restricts the size of the container device.

Thus, there exists a need in the art for an apparatus to improve the bale press such that the transfer device is configured compactly while ensuring its reliability.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

The invention concerns an agricultural bale press. The bale press has a press frame, a container device, and a transfer device. The transfer device is configured for transferring the container device relative to the press frame. The container device can be transferred from an operating position into a filling position. The transfer device has at least one actuator. The transfer device also has at least a first guide element which is arranged at one end pivotably about a first frame guide pivot axis on the press frame and at the other end pivotably about a first container guide pivot axis on the container device. The transfer device also has a guide arrangement which is arranged pivotably about a second container guide pivot axis on the container device. The guide arrangement comprises at least a second guide element, which is arranged pivotably at one end about a second frame guide pivot axis on the press frame.

According to the invention, an agricultural bale press, having a press frame), a container device and a transfer device which is configured for transferring the container device relative to the press frame from an operating position into a filling position, and at least an actuator, at least a first guide element which is arranged at one end pivotably about a first frame guide pivot axis on the press frame and at the other end pivotably about a first container guide pivot axis on the container device, and has a guide arrangement which is arranged pivotably about a second container guide pivot axis on the container device and comprises at least a second guide element which is arranged pivotably at one end about a second frame guide pivot axis on the press frame, wherein the guide arrangement includes at least an intermediate guide element and at least a third guide element, the second guide element is arranged at the other end pivotably about a first intermediate guide pivot axis on the intermediate guide element, the intermediate guide element is arranged pivotably about a second intermediate guide pivot axis on the first guide element, and the third guide element is arranged at one end pivotably about a third intermediate guide pivot axis on the intermediate guide element and at the other end pivotably about the second container pivot axis on the container device.

According to the invention, the guide arrangement comprises at least an intermediate guide element and at least a third guide element. The second guide element is arranged pivotably at one end about the second frame guide pivot axis on the press frame, and at the other end pivotably about a first intermediate guide pivot axis on the intermediate guide element. The intermediate guide element is arranged pivotably about a second intermediate guide pivot axis on the first guide element. The third guide element is arranged at one end pivotably about a third intermediate guide pivot axis on the intermediate guide element and at the other end pivotably about the second container pivot axis on the container device.

The agricultural bale press is, in particular, a square bale or large packing press. To produce a pressed bale, the bale press usually wraps it with a binder such as a yarn. The binder required is carried by the bale press in the form of binder rolls. The container device serves, in particular, to receive the binder rolls to be carried. For this, the container device preferably forms a closed inner space with a plurality of places for positioning a respective binder roll.

In the operating position, the container device preferably forms a side flank of the bale press. Particularly preferably, the bale press has at least two container devices, which are arranged mirror-symmetrically relative to a longitudinal center plane of the bale press. In operation of the bale press, the at least one container device, in particular for providing the contained binder, is in the operating position. In the operating position, the container device is preferably positioned at least partly above a wheel of the bale press, which is configured for rolling over a support surface plane that, in operation in particular, corresponds to the ground surface of the field. To refill the container device, in particular to restock binder rollers, the container device must be transferred to the filling position. In the filling position, the container device is closer to the support surface plane than in the operating position, and, in particular, is laterally offset to the wheel so that the operator of the bale press has comfortable access to the container device.

The press frame is, in particular, a rigid frame, which supports various function units of the bale press. The first guide element and the second guide element are mounted, preferably by means of pivot bearings, on the press frame. The further mutually pivotable components are also preferably mounted on each other by means of pivot bearings. The pivot axes are geometric axes, which extend preferably parallel to one another and/or in the direction of travel of the bale press. The guide elements are preferably rigid, and particularly preferably at least substantially elongate components. The actuator is, in particular, configured as a hydraulic cylinder. Other than the pivotability of said components, these are preferably not movable relative to one another.

Because of the design of the guide arrangement according to the invention, the transfer device is, in particular, configured as a Z kinematic. In detail, the guide arrangement is preferably configured such that the second guide element, the intermediate guide element, and/or the third guide element cross the first guide element in a front or rear view, at least in the operating position, the filling position or an intermediate position in which the container device is arranged during transfer between the operating position and the filling position. The first intermediate guide pivot axis is preferably positioned at one end of the intermediate guide element. The third intermediate guide pivot axis is preferably positioned at the other end of the intermediate guide element.

Because of the design of the bale press according to the invention, a reliable guidance of the container device relative to the press frame can be achieved, wherein the container device in the filling position has at least substantially the same orientation as in the operating position. In comparison with the guide arrangement known from the prior art, the Z kinematic is, however, particularly compact. Therefore, more space is available for further function units of the bale press and the container device. Because of the greater space available for the container device, the bale press can carry a larger stock of binder, whereby the downtimes of the bale press necessary for filling the container device are reduced.

The actuator is preferably arranged in particular at one end pivotably about a frame actuator pivot axis on the press frame. Alternatively, the actuator may, e.g., be arranged pivotably on the container device or between two of the guide elements. This arrangement of the actuator on the press frame simplifies the energy supply and thus increases the reliability of the transfer device.

Particularly preferably, the guide arrangement is configured such that the frame actuator pivot axis is arranged coaxially with the second frame guide pivot axis. This means that the actuator and the second guide element are mounted pivotably about the same axis on the press frame. In particular, this axis and the first frame guide pivot axis are the only axes about which the components of the transfer device are mounted pivotably on the press frame. Because of the coaxial arrangement of the frame actuator pivot axis and the second frame guide pivot axis, the installation space required by the transfer device is significantly reduced and the press frame may be configured structurally simpler with respect to the transfer device.

The first frame guide pivot axis and the second frame guide pivot axis are arranged in a first plane. Preferably, the guide arrangement is configured such that the first plane is angled relative to a support surface plane by at least 45°, preferably by at least 55°, particularly preferably by at least 65°. This guarantees, in particular in the case of congruence of the frame actuator pivot axis and second frame guide pivot axis, that the actuator is sufficiently strong, even when a relatively small force is exerted indirectly, to raise the container device from the filling position, wherein the ratio of a pivot angle of the first guide element to a travel of the container device in a vertical direction is particularly low. The first plane is, in particular, angled by less than 90° to the support surface plane. The actuator, in the case of congruence of the frame actuator pivot axis and the second frame guide pivot axis, can remove the container device from the operating position even if the first frame guide pivot axis and first container guide pivot axis, in the operating position of the container device, lie in a plane at right angles to the support surface plane, wherein a further reduction in installation space requirement of the transfer device is achieved, in particular in the operating position of the container device.

The press frame, in particular, has its maximum width in the region of the first frame guide pivot axis, wherein the second frame guide pivot axis lies closer to the longitudinal center plane than the first frame guide pivot axis. The first frame guide pivot axis is, in particular, arranged above the wheel of the bale press. The distance of the first frame guide pivot axis from the longitudinal center plane is, in particular, greater by 60 mm than the distance of the second frame guide pivot axis from the longitudinal center plane, wherein the distance of the second frame guide pivot axis from the support surface plane is, in particular, greater by 150 mm than the distance of the first frame guide pivot axis from the support surface plane. The direct distance of the frame guide pivot axes from one another is preferably smaller than the distance of the first frame guide pivot axis from the second intermediate guide pivot axis, and/or of the second frame guide pivot axis from the first intermediate guide pivot axis. Thus, even with a small installation space requirement, a relatively broad spacing of the container device from the press frame in the filling position can be achieved.

Preferably, the actuator, in particular at the other end, is arranged pivotably about a guide actuator pivot axis on the first guide element. Alternatively, the actuator could also be arranged on one of the further guide elements or on the container device. Because of the arrangement of the actuator on the first guide element, in particular with the above-described positioning of the frame guide pivot axes relative to one another, a great pivoting of the first guide element can be achieved even on a slight travel distance of the actuator.

Particularly preferably, the guide arrangement is configured such that the guide actuator pivot axis is arranged coaxially with the second intermediate guide pivot axis. This means that the actuator and the intermediate guide element are arranged pivotably about the same axis relative to the first guide element. Because of the congruence of the guide actuator pivot axis and the second intermediate guide pivot axis, the transfer device can be structured particularly compactly.

Preferably, the guide arrangement is configured such that a distance between the second intermediate guide pivot axis and the first frame guide pivot axis is greater than a distance between the second intermediate guide pivot axis and the first container guide pivot axis. The second intermediate guide pivot axis is preferably arranged slightly eccentrically on the first guide element. With this arrangement, in the case of a conventional hydraulic cylinder as actuator, a greater pivot angle of the first guide element relative to the press frame can be achieved. Also, because of the arrangement, with a design of the container device for receiving conventional binder rollers, the holding capacity is restricted as little as possible by the intermediate guide element, which partially protrudes from the first guide element towards the container device, in particular in the operating position of the container device.

Preferably, the container device has a recess into which the intermediate guide element protrudes in the operating position of the container device, such that the first intermediate guide pivot axis intersects the container device. The size of the recess is, in particular, equal to the size of one of the binder roll places inside the container device. The recess is, in particular, arranged such that at least four binding roll places are formed on both sides, offset to the recess in the direction of the first intermediate guide pivot axis. The recess allows a smaller distance between the container device in the operating position and the longitudinal center plane of the bale press, whereby the width of the container device, measured at right angles to the longitudinal center plane, and hence its holding capacity can become larger.

Preferably, the intermediate guide element is configured such that a distance between the first intermediate guide pivot axis and the second intermediate guide pivot axis is smaller than a distance between the second intermediate guide pivot axis and the third intermediate guide pivot axis. As a result, in particular, the installation space required in the direction of the container device, and hence perhaps the necessary transverse extent of the recess, can be reduced.

The guide arrangement is preferably configured such that on transfer, the container device is at least slightly pivoted relative to the press frame. In particular, on transfer from the operating position to the filling position, a lower end of the container device pivots away from the press frame, optimally by an angle of 7.3°. This pivoting can be achieved at least partly by the different distances of the first intermediate guide pivot axis and the third intermediate guide pivot axis from the second intermediate guide pivot axis. The pivoting facilitates guidance of the lower end of the container device next to the wheel, which in particular lies below this in the operating position, so that the container device can be enlarged without colliding with the wheel during transfer.

The first intermediate guide pivot axis and the third intermediate guide pivot axis are arranged in a second plane. The intermediate guide element is preferably configured such that at least in one position of the container device, in particular the operating position, the filling position, or the intermediate position, the second intermediate guide pivot axis is arranged offset to the second plane in a first direction in which also the second frame guide pivot axis is arranged offset to the second plane. In particular, the intermediate guide element has two legs starting from the second intermediate guide pivot axis and formed facing away from the second frame guide pivot axis with respect to the intermediate guide pivot axes, such that they enclose an angle of less than 180°. The first intermediate guide pivot axis can thereby be positioned particularly close to the first guide element in the operating position. Firstly, this again reduces the critical installation space requirement. Secondly, this may achieve that the container device is pivoted substantially relative to the press frame even during the first part of the transfer from the operating position, in order to avoid the wheel at a particularly large distance.

The first guide element is preferably configured such that its length corresponds to at least 80%, preferably at least 90%, particularly preferably at least 100% of a height of the container device in its operating position. In particular, a distance of the first frame guide pivot axis from the first container guide pivot axis corresponds to at least 80%, in particular, at least 90% of the height. In the operating position of the container device, the first guide element preferably extends at least substantially at right angles linearly to the support surface plane. The maximum possible length of the first guide element and the maximum possible axial spacing cause a particularly wide spacing of the container device from the press frame in the filling position. This allows easier access to the container device. Particularly preferably, the length of the first guide element corresponds to the height of the container device in the operating position since, in the case where a service platform of a bale press is situated above the container device in the operating position, the space between the service platform and the wheel can thus be optimally utilized.

The first guide element is preferably mounted on an upper end of the container device. In the operating position of the container device, the first container guide pivot axis is arranged in a third plane at right angles to the support surface plane. Preferably, the guide arrangement is configured such that the second container guide pivot axis, the first frame guide pivot axis, and/or the second intermediate guide pivot axis, in the operating position of the container device, is/are also arranged in the third plane. Thus, the installation space required for the transfer device, in particular transversely to the longitudinal center plane, can be further reduced.

Preferably, the guide arrangement is configured such that a distance between the first container guide pivot axis and the second container guide pivot axis amounts at most to 50%, preferably at most 40%, particularly preferably at most 30% of a distance between the first container guide pivot axis and the first frame guide pivot axis. This means, in particular, that the second container guide pivot axis is spaced only slightly from the upper end of the container device. This may be achieved firstly that the container device is guided particularly close to the support surface plane without the transfer device colliding with the wheel. Also, because of the small mutual spacing of the guide container pivot axes, the mutual spacings of the intermediate guide pivot axes can be reduced, leading to an installation space advantage without jeopardizing the intended movement of the container device relative to the press frame.

Preferably, the transfer device has two first guide elements, which are spaced apart from one another in the direction of the pivot axes. The transfer device has preferably precisely one actuator, which, at least in the operating position of the container device, is arranged at least partially, preferably centrally, between the first guide elements. The same preferably applies to the second guide element, the intermediate guide element, and/or the third guide element. Particularly preferably, the transfer device is configured mirror-symmetrically to a mirror plane which is positioned at right angles to both the support surface plane and also to the longitudinal center plane. The second guide element and/or the intermediate guide element preferably have two identically formed portions between which at least a part of the actuator is arranged. In particular, on both first guide elements, a stiffening element is stationarily arranged, which extends as an arc to the intermediate guide element. Adjacent to the first container guide pivot axis, the first guide elements are preferably connected together by a stiffening brace extending parallel to the first container guide pivot axis.

Preferably, the second guide element and/or the third guide element has/have a further actuator. As a result, the distance of the second frame guide pivot axis to the first intermediate guide pivot axis, and/or the distance of the third intermediate guide pivot axis to the second container guide pivot axis, is variable. The further actuator is preferably controllable independently of the first actuator. This achieves a further degree of freedom of the transfer device, and for example, the container device can be pivoted out of the operating position initially only about the first container guide pivot axis, before it is moved into the filling position on the support surface plane. Alternatively or additionally, the length of the second guide element and/or the third guide element can be changed manually in order to adjust the transfer device before commissioning of the bale press.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated. further details and advantages of the invention are given in the following description of the exemplary embodiment, illustrated schematically. In the drawings:

FIG. 1 shows an agricultural bale press according to the invention in a partially sectioned front view.

FIG. 2a shows a transfer device of the bale press from FIG. 1 in an operating position in a front view.

FIG. 2b shows the transfer device of the bale press from FIG. 1 in an intermediate position in a front view.

FIG. 2c shows the transfer device of the bale press from FIG. 1 in a filling position in a front view.

FIG. 3a shows the transfer device of the bale press from FIG. 1 in the operating position in a perspective view.

FIG. 3b shows the transfer device of the bale press from FIG. 1 in the intermediate position in a perspective view.

FIG. 3c shows the transfer device of the bale press from FIG. 1 in the filling position in a perspective view.

FIG. 4a shows the transfer device of the bale press from FIG. 1 in the operating position in a plan view.

FIG. 4b shows the transfer device of the bale press from FIG. 1 in the intermediate position in a plan view.

FIG. 4c shows the transfer device of the bale press from FIG. 1 in the filling position in a plan view; and

FIG. 5 shows the transfer device of the bale press from FIG. 1 in the intermediate position in a simplified front view.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

The features of the exemplary embodiment according to the invention explained below may also be the subject of the invention individually or in combinations other than those illustrated or described, but always at least in combination with the features of claim 1. Where suitable, functionally equivalent parts carry identical reference signs.

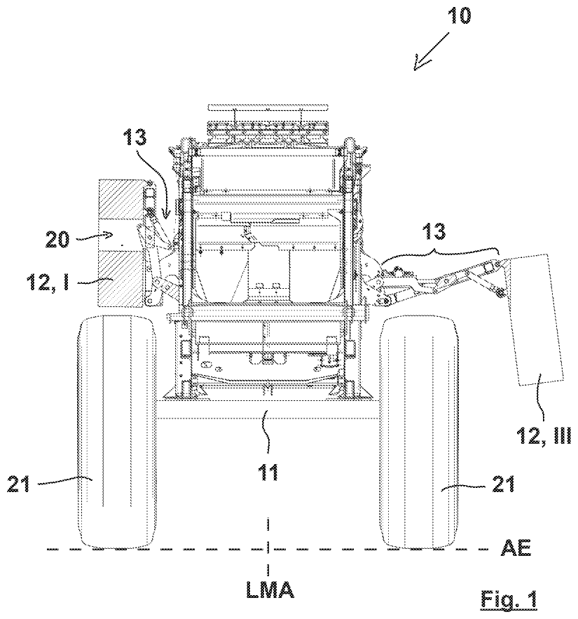

The figures show an agricultural bale press 10 according to the invention in full or in part. FIG. 1 shows the bale press 10 as a whole. The bale press 10 has a press frame 11, including a wheel axle and wheels 21 arranged thereon. The wheels 21 of the bale press 10 stand on a support surface plane AE. Above the wheel 21 shown on the left in FIG. 1, a container device 12 is illustrated in an operating position I. Next to the wheel 21, shown on the right in FIG. 1, a further container device 12 is illustrated in a filling position III. The two container devices 12 are arranged on the press frame 11 by means of identical transfer device 13.

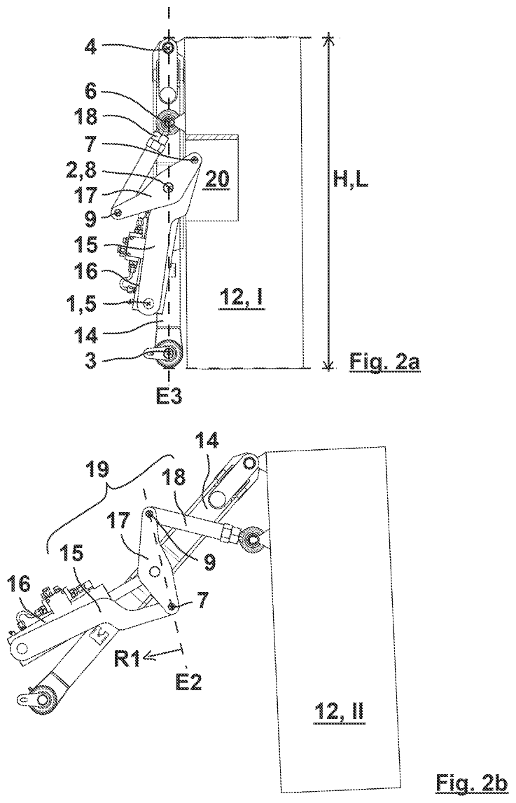

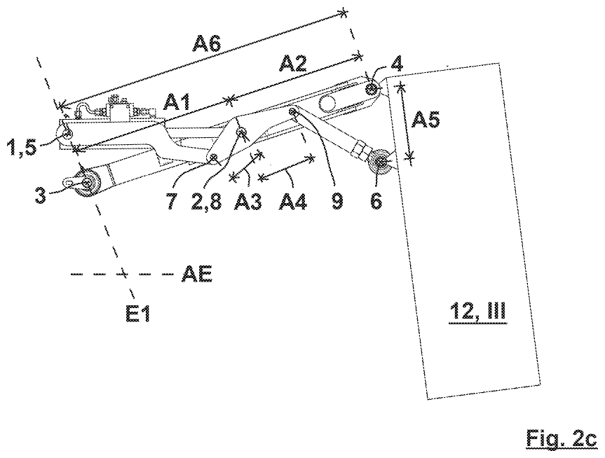

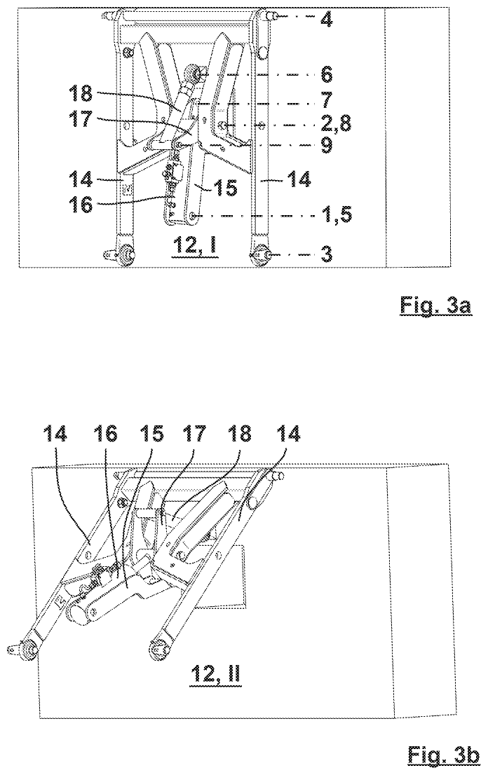

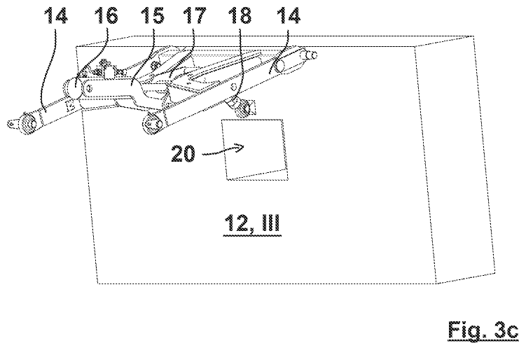

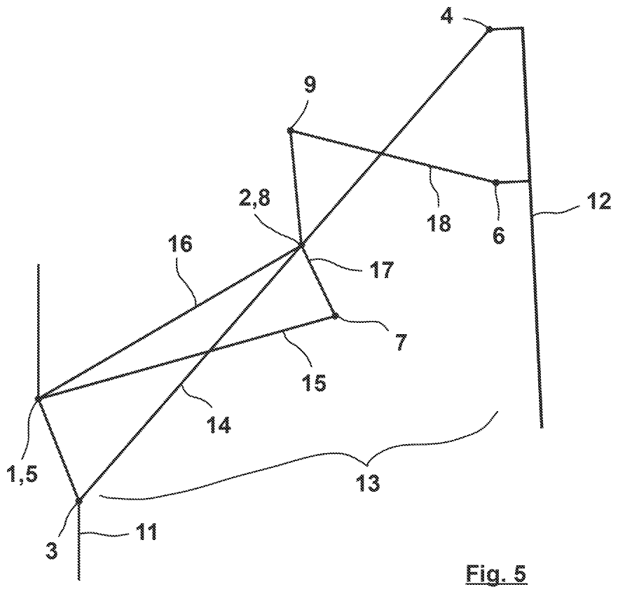

The configuration of the transfer device 13 illustrated above the wheel 21 shown on the right in FIG. 1 is shown in detail in FIGS. 2a to 5. FIGS. 2a, 3a, and 4a show the container device 12 arranged on the transfer device 13 in the operating position I; FIGS. 2b, 3b, 4b, and 5 show the container device 12 in the intermediate position II; and FIGS. 2c, 3c, and 4c show the container device 12 in the filling position III.

The transfer device 13 has two first guide elements 14, which are arranged at one end pivotably about a first frame guide pivot axis 3 on the press frame 11. At the other end, the first guide elements 14 are arranged pivotably about a first container guide pivot axis 4 on the container device 12. Also, the transfer device 13 comprises a guide arrangement 19, which has a second guide element 15, an intermediate guide element 17, and a third guide element 18 (see FIG. 2b). The second guide element 15 is arranged at one end pivotably about a second frame guide pivot axis 5 on the press frame 11. The second guide element 15 is arranged at the other end pivotably about a first intermediate guide pivot axis 7 on the intermediate guide element 17. The intermediate guide element 17 is arranged pivotably about a second intermediate guide pivot axis 8 on the first guide element 14. The third guide element 18 is arranged at one end pivotably about a third intermediate guide pivot axis 9 on the intermediate guide element 17. At the other end, the third guide element 18 is arranged pivotably about a second container guide pivot axis 6 on the container device 12.

The transfer device 13 has an actuator 16 configured as a hydraulic cylinder. One end of the actuator 16 is arranged on the press frame 11 so as to be pivotable about a frame actuator pivot axis 1, which is arranged coaxially with the second frame guide pivot axis 5. The other end of the actuator 16 is arranged on the first guide element 14 so as to be pivotable about a guide actuator pivot axis 2, which is arranged coaxially with the second intermediate guide pivot axis 8.

The first frame guide pivot axis 3 and the second frame guide pivot axis 5 are arranged in a first plane E1 (see FIG. 2c). The first plane E1 is angled at more than 65° to the support surface plane AE, which in FIG. 2c is shown shifted relative to the transfer device 13 for greater clarity. There is a distance A1 between the second intermediate guide pivot axis 8 and the first frame guide pivot axis 3. There is a distance A2 between the second intermediate guide pivot axis 8 and the first container guide pivot axis 4. The distance A1 is greater than the distance A2 (see FIG. 2c). There is a distance A3 between the first intermediate guide pivot axis 7 and the second intermediate guide pivot axis 8. There is a distance A4 between the second intermediate guide pivot axis 8 and the third intermediate guide pivot axis 9. The distance A3 is smaller than the distance A4 (see FIG. 2c). There is a distance A5 between the first guide container pivot axis 4 and the second guide container pivot axis 6. There is a distance A6 between the first container guide pivot axis 4 and the first frame guide pivot axis 3. The distance A5 amounts to a maximum of 30% of the distance A6 (see FIG. 2c).

The first intermediate guide pivot axis 7 and the third intermediate guide pivot axis 9 are arranged in a second plane E2. The second intermediate guide pivot axis 8 is arranged offset to the second plane E2 in a first direction R1. The second frame guide pivot axis 5 is also arranged offset to the second plane E2 in the first direction R1 (see FIG. 2b). A length L of the first guide element 14 equals a height H of the container device 12 in its operating position I (see FIG. 2a). The first container guide pivot axis 4 and the second container guide pivot axis 6 are arranged in a third plane E3 in the operating position I of the container device 12. The third plane E3 is arranged at right angles to the support surface plane AE. The third plane E3, contains also the first frame guide pivot axis 3 and the second intermediate guide pivot axis 8 in the operating position I of the container device 12 (see FIG. 2a).

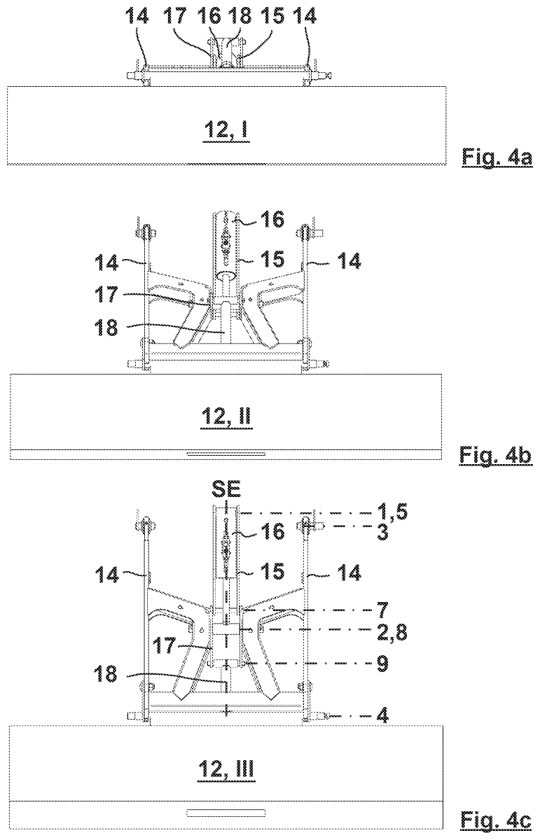

The container device 12 has a recess 20. In the operating position I of the container device 12, the intermediate guide element 17 protrudes into the recess 20 such that the first intermediate guide pivot axis 7 intersects the container device 12 (see FIGS. 1, 2a, and 2c). The transfer devices 13 of the bale press 10 are arranged mirror-symmetrically to one another relative to a longitudinal center plane LMA of the bale press 10 (see FIG. 1). The transfer devices 13 are each configured mirror-symmetrically relative to a mirror plane SE (see FIG. 4c).

From the foregoing, it can be seen that the present disclosure accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 1 | Frame actuator pivot axis |
| 2 | Guide actuator pivot axis |
| 3 | First frame guide pivot axis |
| 4 | First container guide pivot axis |
| 5 | Second frame guide pivot axis |
| 6 | Second container guide pivot axis |
| 7 | First intermediate guide pivot axis |
| 8 | Second intermediate guide pivot axis |
| 9 | Third intermediate guide pivot axis |
| 10 | Agricultural bale press |
| 11 | Press frame |
| 12 | Container device |
| 13 | Transfer device(s) |
| 14 | First guide elements |
| 15 | Second guide element |
| 16 | Actuator |
| 17 | Intermediate guide element |
| 18 | Third guide element |
| 19 | Guide arrangement |
| 20 | Recess |
| 21 | Wheel(s) |
| I | Operating position |
| II | Intermediate position |
| III | Filing position |
| A1 | Distance between the second intermediate guide pivot axis 8 and |
| | the first frame guide pivot axis 3. |
| A2 | Distance between the second intermediate guide pivot axis 8 and |
| | the first container guide pivot axis 4 |
| A3 | Distance between the first intermediate guide pivot axis 7 and |
| | the second intermediate guide pivot axis 8. |
| A4 | Distance between the second intermediate guide pivot axis 8 and |
| | the third intermediate guide pivot axis 9. |
| A5 | Distance between the first guide container pivot axis 4 and the |
| | second container guide pivot axis 6. |
| A6 | Distance between the first container guide pivot axis 4 and the |
| | first frame guide pivot axis 3. |
| AE | Support surface plane |
| E1 | First plane |
| E2 | Second plane |
| E3 | Third plane |
| H | Height |
| L | Length of the first guide element |
| LMA | longitudinal center plane |
| R1 | First direction |
| SE | Mirror plane |

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. An agricultural bale press (10) comprising:
a press frame (11);
a container device (12);
a transfer device (13), which is configured for transferring the container device (12) relative to the press frame (11) from an operating position (I) into a filling position (III);
at least an actuator (16); and
at least a first guide element (14) which is arranged at one end pivotably about a first frame guide pivot axis (3) on the press frame (11) and at the other end pivotably about a first container guide pivot axis (4) on the container device (12), and has a guide arrangement (19) which is arranged pivotably about a second container guide pivot axis (6) on the container device (12) and includes at least a second guide element (15) which is arranged pivotably at one end about a second frame guide pivot axis (5) on the press frame (11), wherein the guide arrangement (19) comprises at least an intermediate guide element (17) and at least a third guide element (18), the second guide element (15) is arranged at the other end pivotably about a first intermediate guide pivot axis (7) on the intermediate guide element (17), the intermediate guide element (17) is arranged pivotably about a second intermediate guide pivot axis (8) on the first guide element (14), and the third guide element (18) is arranged at one end pivotably about a third intermediate guide pivot axis (9) on the intermediate guide element (17) and at the other end pivotably about the second container pivot axis (6) on the container device (12).

2. The agricultural bale press (10) according to claim 1, wherein the actuator (16) is arranged pivotably about a frame actuator pivot axis (1) on the press frame (11).

3. The agricultural bale press (10) according to claim 1, the guide arrangement (19) includes the frame actuator pivot axis (1) arranged coaxially with the second frame guide pivot axis (5).

4. The agricultural bale press (10) according to claim 1, wherein the guide arrangement (19) includes a first plane (E1) containing the first frame guide pivot axis (3) and the second frame guide pivot axis (5) is angled relative to a support surface plane (AE) by at least 45°.

5. The agricultural bale press (10) according to claim 1, wherein the guide arrangement (19) includes a first plane (E1) containing the first frame guide pivot axis (3) and the second frame guide pivot axis (5) is angled relative to a support surface plane (AE) by at least at least 55°.

6. The agricultural bale press (10) according to claim 1, wherein the guide arrangement (19) includes a first plane (E1) containing the first frame guide pivot axis (3) and the second frame guide pivot axis (5) is angled relative to a support surface plane (AE) by at least at least 65°.

7. The agricultural bale press (10) according to claim 2, wherein the actuator (16) is arranged pivotably about a guide actuator pivot axis (2) on the first guide element (14).

8. The agricultural bale press (10) according to claim 1, wherein the guide arrangement (19) includes the guide actuator pivot axis (2) arranged coaxially with the second intermediate guide pivot axis (8).

9. The agricultural bale press (10) according to claim 1, wherein the guide arrangement (19) includes a distance (A1) between the second intermediate guide pivot axis (8) and the first frame guide pivot axis (3) is greater than a distance (A2) between the second intermediate guide pivot axis (8) and the first container guide pivot axis (4).

10. The agricultural bale press (10) according to claim 1, wherein the container device (12) has a recess (20) into which the intermediate guide element (17) protrudes in the operating position (I) of the container device (12), such that the first intermediate guide pivot axis (7) intersects the container device (12).

11. The agricultural bale press (10) according to claim 1, wherein the intermediate guide element (17) includes a distance (A3) between the first intermediate guide pivot axis (7) and the second intermediate guide pivot axis (8) is smaller than a distance (A4) between the second intermediate guide pivot axis (8) and the third intermediate guide pivot axis (9).

12. The agricultural bale press (10) according to claim 1, wherein the intermediate guide element (17) such that the second intermediate guide pivot axis (8), at least in a position of the container device (12), is arranged offset relative to a second plane (E2) containing the first intermediate guide pivot axis (7) and the third intermediate guide pivot axis (9), in a first direction (R1) in which also the second frame guide pivot axis (5) is arranged offset to the second plane (E2).

13. The agricultural bale press (10) according to claim 1, wherein the first guide element (14) has a length (L) that corresponds to at least 80% of a height (H) of the container device (12) in its operating position (I).

14. The agricultural bale press (10) according to claim 1, wherein the first guide element (14) has a length (L) that corresponds to at least 90% of a height (H) of the container device (12) in its operating position (I).

15. The agricultural bale press (10) according to claim 1, wherein the first guide element (14) has a length (L) that corresponds to at least 100% of a height (H) of the container device (12) in its operating position (I).

16. The agricultural bale press (10) according to claim 1, wherein the guide arrangement (19) includes the third plane (E3), containing the first container guide pivot axis (4) and the second container guide pivot axis (6) in the operating position (I) of the container device (12), is arranged at right angles to a support surface plane (AE) of the bale press (10).

17. The agricultural bale press (10) according to claim 1, wherein the guide arrangement (19) includes the operating position (I) of the container device (12), the first frame guide pivot axis (3) and/or the second intermediate guide pivot axis (8) is/are arranged in the third plane (E3).

18. The agricultural bale press (10) according to claim 1, wherein the guide arrangement (19) includes a distance (A5) between the first container guide pivot axis (4) and the second container guide pivot axis (6) amounts at most to 50% of a distance (A6) between the first container guide pivot axis (4) and the first frame guide pivot axis (3).

19. The agricultural bale press (10) according to claim 1, wherein the guide arrangement (19) includes a distance (A5) between the first container guide pivot axis (4) and the second container guide pivot axis (6) amounts at most to 40% of a distance (A6) between the first container guide pivot axis (4) and the first frame guide pivot axis (3).

20. The agricultural bale press (10) according to claim 1, wherein the guide arrangement (19) includes a distance (A5) between the first container guide pivot axis (4) and the second container guide pivot axis (6) amounts at most 30%, of a distance (A6) between the first container guide pivot axis (4) and the first frame guide pivot axis (3).

21. The agricultural bale press (10) according to claim 1, wherein the actuator (16), the second guide element (15), the intermediate guide element (17) and/or the third guide element (18) are arranged at least partly between the first guide elements (14) in the operating position (I) of the container device (12).

22. The agricultural bale press (10) according to claim 1, wherein the second guide element (15) and/or the third guide element (18) has/have a further actuator.
